(19) United States
(12) Patent Application Publication
(10) Pub. No.: US 2018/0012499 A1
(43) Pub. Date: Jan. 11, 2018

(54) System and Method for Predicting Aircraft Taxi Time

(71) Applicant: PASSUR Aerospace, Inc., STAMFORD, CT (US)

(72) Inventors: Madhuri Tata Madhusudan, STAMFORD, CT (US); Thomas WHITE, STAMFORD, CT (US); Matthew Marcella, STAMFORD, CT (US); Priyadharshini Krishnamurthy, STAMFORD, CT (US)

(21) Appl. No.: 15/644,361

(22) Filed: Jul. 7, 2017

Related U.S. Application Data
(60) Provisional application No. 62/359,515, filed on Jul. 7, 2016.

(51) Int. Cl. G08G 5/00; G06Q 50/30

(52) U.S. Cl. CPC G08G 5/0013; G06Q 50/30

(57) ABSTRACT

A system and method predicts a taxi time for an aircraft. The method includes receiving historical flight information including a set of historical airspace conditions at a target airport. The method includes comparing real time flight information of a target aircraft to the historical flight information. The method includes identifying matched airspace conditions. The method includes determining historical taxi time information corresponding to the matched airspace conditions. The method includes determining a combined historical performance based on the matched airspace conditions and the historical taxi time information, the combined historical performance incorporating an interdependency between discrete characteristics of the matched airspace conditions and the historical taxi time information. The method includes determining an estimate for a taxi time duration for the aircraft based on the combined historical performance.

### PRIORITY CLAIM/INCORPORATION BY REFERENCE

The present application claims priority to U.S. Provisional Patent Application 62/359,515 filed on Jul. 7, 2016 entitled “System and Method for Predicting Aircraft Taxi Time” naming Madhuri Tata Madhusudan, Thomas White, Matthew Marcella, and Priyadharshini Krishnamurthy as inventors, and hereby incorporates, by reference, the entire subject matter of this Provisional Application.

### BACKGROUND

Current estimated time of aircraft information (e.g., taxi time duration, arrival (“ETA”) information, etc.) is only an approximation of when the aircraft will land on the runway. However, there may be multiple reasons for individuals to desire to know the estimated time of arrival to a gate (“ETAG”). This ETA is a more accurate prediction of the actual time of arrival of the passengers. For example, an aircraft may arrive on the runway at a particular time, but be unable to pull up to an airport gate until much later, due to certain airport conditions (e.g., small airport and not enough gates to accommodate all arriving flights, etc.). This may create problems for passengers in terms of missed connecting flights, pre-planned travel itineraries, travel arrangements from the airport, etc. The ETA of aircrafts to the airport gate will allow individuals to choose connecting flights accordingly and provide a more accurate time frame for making travel arrangements from the airport.

The taxi time duration and ETA to an airport gate may also be useful for airports and airlines. This information may allow airports to optimize gate and ramp management and improve efficiency. It may also allow airlines to provide accurate information to their passengers for greater consumer satisfaction. These are only a few examples of the usefulness of predicting taxi time duration for aircraft and the ETA to arrival gates. There are many other reasons why such information may need to be known to individuals, agencies, airlines, etc. However, the taxi time duration and the ETA to an airport gate are determined based on discrete factors that do not consider how these factors may have a dependency to each other. Therefore, calculations to determine the taxi time duration and the ETA to an airport gate are often inaccurate and provide an incorrect estimation.

### SUMMARY OF THE INVENTION

The exemplary embodiments are directed to a method, comprising: receiving historical flight information including a set of historical airspace conditions at a target airport; comparing real time flight information of a target aircraft to the historical flight information; identifying at least one real time airspace condition of the real time flight information as matching at least one historical airspace condition of the set of historical airspace conditions; determining historical taxi time information corresponding to the at least one historical airspace condition of the set of historical airspace conditions; determining a combined historical performance based on the matched at least one real time airspace condition and the historical taxi time information, the combined historical performance incorporating an interdependency between discrete characteristics of the matched at least one real time airspace condition and the historical taxi time information; and determining an estimate for a taxi time duration for the aircraft based on the combined historical performance.

The exemplary embodiments are directed to an airport demand server, comprising: a transceiver configured to receive historical flight information including a set of historical airspace conditions at a target airport; and a taxi time prediction module comparing real time flight information of a target aircraft to the historical flight information, the taxi time prediction module identifying at least one real time airspace condition of the real time flight information as matching at least one historical airspace condition of the set of historical airspace conditions, the taxi time prediction module determining historical taxi time information corresponding to the at least one historical airspace condition of the set of historical airspace conditions, the taxi time prediction module determining a combined historical performance based on the matched at least one real time airspace condition and the historical taxi time information, the combined historical performance incorporating an interdependency between discrete characteristics of the matched at least one real time airspace condition and the historical taxi time information, the taxi time prediction module determining an estimate for a taxi time duration for the aircraft based on the combined historical performance.

The exemplary embodiments are directed to a non-transitory computer readable storage medium with an executable program stored thereon, wherein the program instructs a microprocessor to perform operations comprising: receiving historical flight information including a set of historical airspace conditions at a target airport; comparing real time flight information of a target aircraft to the historical flight information; identifying at least one real time airspace condition of the real time flight information as matching at least one historical airspace condition of the set of historical airspace conditions; determining historical taxi time information corresponding to the at least one historical airspace condition of the set of historical airspace conditions; determining a combined historical performance based on the matched at least one real time airspace condition and the historical taxi time information, the combined historical performance incorporating an interdependency between discrete characteristics of the matched at least one real time airspace condition and the historical taxi time information; and determining an estimate for a taxi time duration for the aircraft based on the combined historical performance.

### DESCRIPTION OF THE DRAWINGS

FIG. 1 shows an exemplary system for predicting taxi time durations for an aircraft according to the exemplary embodiments described herein.

FIG. 2 shows an exemplary method for predicting taxi time durations for an aircraft according to the exemplary embodiments described herein.

### DETAILED DESCRIPTION

The exemplary embodiments may be further understood with reference to the following description and to the appended drawings, wherein like elements are referred to with the same reference numerals. The exemplary embodiments comprise a communications network which is designed to communicate an estimated taxi time duration for aircrafts from a current location (e.g., a runway) to an airport gate or vice versa. Specifically, the exemplary embodiments described herein provide a technique to model airport demand for the purpose of predicting accurate taxi time durations for future flights. As will be described in further detail below, the mechanism according to the exemplary embodiments incorporate factors beyond discrete characteristics of the historical information pertaining to airport/aircraft such as interdependencies of these discrete characteristics. In this manner, the exemplary embodiments utilize a holistic approach that views the scenario as a whole based on the conditions that are identified relative to historical conditions. Through this holistic approach, the exemplary embodiments are configured to determine a more accurate estimation of taxi time duration for a selected aircraft as not only discrete factors are considered but interdependencies are further considered. That is, the exemplary embodiments transform the historical information into an appropriate benchmark to determine an accurate estimation of taxi time duration. In this manner, the mechanisms adopted to estimate the taxi time duration are improved and a more efficient process is utilized that has an improved accuracy from consideration of all encompassing aspects.

As will be described in greater detail below, the exemplary systems and methods for predicting taxi time duration may be built up by identifying historical airport traffic on the ground, such as airport density, arrival and departure queues, etc. Through the use of predictive analytics and pattern recognition, the exemplary embodiments may be able to identify similar conditions of a target aircraft to those airspace and airport conditions of the historical information. Again, this identification involves both identification of discrete factors as well as how these discrete factors are related to one another (if applicable). As opposed to simply relying on a time of day, a day of the week, or any other time-based methods to predict the demand of airport surface space such as runways, gates, etc. (i.e., based on discrete factors only), the exemplary systems and methods may utilize several further factors or conditions (e.g., interdependency) to model airport demand in a holistic approach.

The factors used in modeling the airport demand and predicting taxi time duration may include past aircraft information derived from passive and active radar sources, as well as airline identification information. Exemplary types of information derived from passive and active radar sources will be provided below. Additional information may include details pertaining to the four phases of a flight, namely, OUT of the departure gate, OFF the ground, ON the ground at destination airport, and IN the arrival gate (e.g., OUT, OFF, ON and IN times). This information may be collected for all arriving and departing flights at the airport for which the taxi time is to be estimated.

Another factor used in modeling airport demand may be runway usage information (both predicted and actual). It is noted that runway identification is used in the predictive process since taxi time durations may vary greatly based on which runway the target aircraft arrives or departs. Methods for predicting runways may use recently landed flight information. Furthermore, predictions of airport conditions may use weather forecast information and airport demand at various times of day may also be used to predict runways. It should be noted that the exemplary embodiments may include the runway prediction functionality or the runway predictions may be received from a separate runway prediction system.

Another factor used in modeling airport demand may be estimated times of arrivals of all aircraft in the national airspace. For example, estimated times of arrivals may indicate the level of congestion of various portions of airspace and may be used to determine the airport demand at the target airport for any given time. Similar to the runway prediction functionality, the estimated time of arrival functionality for arriving flights may be included in the exemplary embodiments or may be received from an external system created for such a purpose. In addition to arrival times, another factor used in modeling airport demand may be departure times of flights for the target airport. The exemplary systems and methods may calculate time of departure estimates using past performance information of each flight, e.g., using the departure gate information, the OUT information and the OFF information of previous flights.

A further factor used in modeling airport demand may be regions of interest (e.g., location-based polygons) at the target airport. For example, the ground area of the target airport may be divided into multiple regions of interest and transit times of current and past aircraft through or between these regions of interest may be used to model patterns that best match a predicted condition.

Further information may include estimated times of arrival, past taxi times, airport active runway configurations, Notice to Airmen (“NOTAM”) conditions for closed runways and taxiways for all aircraft at the airport (or expected to be at the airport) during the target aircraft's expected taxi time, etc.

The above provided a series of examples of information that may be used to build the model of the airport demand. It should be noted that the above information is only exemplary and other types of information may also be used to build the model of the airport demand. From the above exemplary information, it can be seen that the information used to build the model provides an insight into the airport traffic on the ground under various conditions. Once the model of the airport demand is built, pattern recognition techniques may be used to automatically identify and match predicted conditions of a target aircraft with prior performance information under a similar set of conditions. This information may then be used to accurately predict the estimated taxi time of the target aircraft.

The information related to the prediction of taxi time duration may be viewed through the use of programs that access and display files and other data available on the communications network such as, for example, a web browser. The system may be accessible by a plurality of users such as, for example, airlines, terminal operators, passengers, etc. One exemplary embodiment of the present invention is described as a web based system. However, those skilled in the art will understand that there may be any number of other manners of implementing the present invention in embodiments that are not web based.

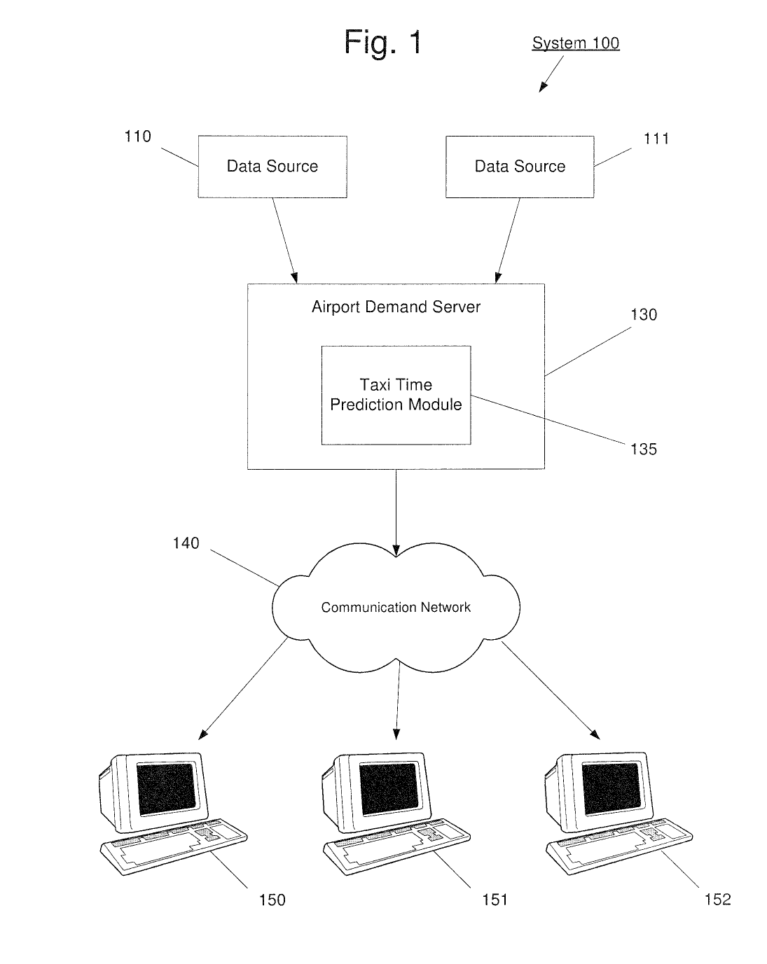

FIG. 1 shows an exemplary system 100 for predicting aircraft taxi time durations according to the exemplary embodiments. The exemplary system 100 may build airport demand models and data structures using past aircraft information in a holistic manner with respect to other departing and arriving aircraft at a given time in history. That is, the taxi time durations for a target aircraft do not only depend on the information for the target aircraft, but also depend on the interactions with other aircraft that may be on the ground or are expected to be on the ground when the target aircraft is taxiing. Thus, the exemplary system 100 may incorporate the conditions of the airport and airspace in the modeling, such as traffic conditions, (e.g., arrival and departure queues). The interdependencies of all aircraft operating contemporaneously (or nearly at the same time) may be taken into account by the system 100. Furthermore, the system 100 may monitor and adjust to any change in the various conditions, such as, but not limited to, airport capacity changes based on weather, closed runways or taxiways, Federal Aviation Administration (“FAA”) ground delays, Traffic Management Initiative (“TMIs”), NOTAMs, as well as other factors.

According to one exemplary embodiment, the system 100 may use real time information from passive and active radar systems as well as airport and airline information for determining an estimated taxi time duration. For instance, data used to generate the predictions may be obtained from at least two data sources 110 and 111 that may be connected to an airport demand server 130. The airport demand server 130 may be connected to a communications network 140. The communications network 140 may allow users 150-152 to access the information generated by the airport demand server 130. The user's stations 150-152 may be, for example, any type of computing platform having network or modem access.

The airport demand server 130 while shown as a separate component may be, a module or other component, that is included in other hardware and/or software. The actual physical implementation of the airport demand server 130 is not critical to the exemplary embodiment. Thus, any component that incorporates the functionality described herein for the airport demand server 130 is sufficient. In addition, the airport demand server 130 is shown as including a taxi time prediction module 135 for predicting the taxi time of an aircraft at an airport gate. The airport demand server 130 may also include an ETA, a runway and/or landing prediction modules (not shown) that is used to predict additional information pertaining to the target aircraft and/or airport.

In an exemplary embodiment depicted in FIG. 1, two data sources 110 and 111 are shown. However, those skilled in the art will understand from this description that any number of data sources may be used to collect data that may be used to predict a taxi time duration. One of the data sources 110 may be a data feed from a passive radar system. An exemplary passive radar system may be, for example, the PASSUR System sold by PASSUR Aerospace, Inc. of Stamford, Conn. As noted above, the information is not limited to be received from a passive radar system. Accordingly, data sources 110 and 111 may include additional feeds, such as information provided from active radar systems such as an FAA feed.

The information provided by the active and/or passive radar systems may include target data points for a particular aircraft. These target data points may include, for example, the time (e.g., UNIX time), the x-position, the y-position, altitude, x-velocity component, y-velocity component, z-velocity component, the speed, the flight number, the airline, the aircraft type, the tail number, etc.

To predict information such as the taxi time duration of a target aircraft, data that is collected by the radar systems for the aircraft being monitored as well as previously monitored aircraft information may be utilized. For example, the passive data source 110 may provide the aircraft current position, arrival airport runway configuration, runway ETA's and landing times of aircraft that preceded the aircraft in question (e.g., previous days, months, years), etc. The taxi time prediction module 135 of the airport demand server 130 may then use this information to generate a prediction of a taxi time duration of the aircraft being monitored.

However, as described above, the information provided by the passive radar data source 110 may not be sufficient to predict the gate ETA. Thus, in this exemplary embodiment at least one other data source 111 is provided to provide the airport demand server 130 with additional information so that the taxi time prediction module 135 may predict the taxi time duration for the aircraft.

Due to the complicated nature of airspace and airport demand modeling, the exemplary system 100 may incorporate real life factors into the model by using the actual performance of historical airport events. Accordingly, the varying interdependencies of all the factors that may affect the airport demand and the airport capacity may be recognized and accounted for by the airport demand server 130, both directly and indirectly. Through the use of real historical performance of aircraft under similar airspace and airport patterns (e.g., conditions), the airport demand server 130 and the taxi time prediction module 135 may yield improved results over any other models based purely on simulations of a list of discretely modeled factors. Specifically, the real historical performance of aircraft may provide insight to the interdependencies of the factors that are being utilized in determining the taxi time duration.

A further feature of the exemplary system 100 is the use of pattern matching techniques to find similar conditions (e.g., airspace conditions, airport conditions, etc.) regardless of the time of the day, day of the week, or other time-based dependencies. Accordingly, the system 100 may automatically adjust for late flights, early flights, and other factors. For instance, the system 100 may explicitly factor any causes for delays (e.g., a bad weather day in an airspace that is affecting several flights) into the real time calculations of predicted taxi time durations.

According to the exemplary embodiments of the system 100, any number of factors may be utilized by the airport demand server 100 to find reliable airport demand parameters. The factors may include estimated time of arrival for all flights landing at the target airport, scheduled times of arrival for aircraft that have not yet departed, scheduled time of departure for flights at the airport in which the target aircraft is landing, predicted runway information (e.g., conditions, configurations, closings, etc.), actual arrival and departure rate information, etc. For the scheduled time of arrivals and time of departures for flights, it is noted that a probability weighting may be assigned to each of these flights based on further factors, such as, but not limited to, past history of flights, delays based on connecting flights, airport delay averages, probability profile of an airline, etc.

The following will provide exemplary additional information that may be used to predict the taxi time duration of a target aircraft. However, those skilled in the art will understand that other information in addition to, or exclusive from, the exemplary information may also be used. A first category of additional information that may be introduced to aid in the prediction of the taxi time is gate arrival information. This information includes, for example, the gate number to which the aircraft is scheduled to arrive. An exemplary data source 111 that may provide this gate arrival information may be a third party vendor that tracks gate arrival information or the airline itself. In either case, the data source 111 may be an automated feed that provides the gate arrival information.

By providing the passive radar data from the data source 110 and the gate arrival information from the data source 111, the taxi time prediction module 135 may predict the taxi time duration for the aircraft. For example, the taxi time prediction module 135 could predict the taxi time duration using the data described above and receive a runway ETA from a runway ETA prediction module. The taxi time prediction module 135 used in conjunction with the ETA prediction module can then use the gate arrival information to determine the gate at which the aircraft is scheduled to arrive and then use the historical data of, for example, an average time from actual runway arrival to the specific gate to which the aircraft is scheduled to arrive, thereby calculating the predicted taxi time duration and gate ETA from the passive radar data and the gate arrival information (including historical data).

While the gate arrival information may be used to predict the gate ETA, the taxi time prediction module 135 may use additional information to more accurately predict the taxi time duration for the target aircraft. This second category of additional information may be the landed runway information. The landed runway information may be input from a runway prediction program, the filed flight plan, the airline's database, etc. The runway prediction algorithm may predict the runway that the aircraft is going to land on based on a variety of factors. For example, the passive data may include location, heading and speed information from which the passive system may predict the runway on which the aircraft will land. In addition, the passive system may have historical data that can be combined with the data collected for the particular aircraft to predict the landed runway.

Thus, if the taxi time prediction module 135 has received the gate arrival information and the landed runway information, the gate prediction module may now use the same method described above when only having the gate arrival information, except that now the taxi time prediction module 135 may only look at historical data for aircraft that have come from the landed runway to the arrival gate. This may further refine the predicted taxi time duration with adjustments based on changing conditions and factors (e.g., predicted gate ETA, etc.).

It should be noted that the predicted taxi time duration may be constantly updated by the taxi time prediction module 135. For example, a first taxi time may be based on the passive data prediction of the runway ETA, the gate arrival information and the predicted landed runway. However, after the aircraft has landed, the runway ETA and the landed runway become certain information. Thus, the taxi time prediction module 135 may substitute this certain information for the predicted information to refine the taxi time duration calculations.

It should be further noted that the historical data may also be refined based on the airport conditions. For example, the historical data may be separated or categorized by the airport demand server 130 based on the operating conditions of the airport. Thus, there may be a first average time for transit from the landed runway to the gate when the visibility is clear and it is daytime, a second average time when it is night time, a third average time on a weekend, a fourth average time on a holiday travel day, a fifth average time when the airport is experiencing an abnormal operation condition (e.g., weather emergency), etc. Thus, when the historical data is collected, another data source may also collect the data on the airport operating condition so that this information may be factored into predicting the taxi time duration.

Thus, the exemplary embodiments allow for the taxi time prediction module 135 of the airport demand server 130 to predict the taxi time for aircraft arriving at an airport. This information may then be disseminated to interested parties 150-152 via the communication network 140. In one exemplary embodiment, the airport demand server 130 (or other device) may host a web server that makes a web page available with the gate ETA predictions for the incoming aircraft. However, the taxi time duration predictions may be disseminated in any number of manners including, for example, sending emails or text messages to subscribed members, sending data to an airline or airport control center so the taxi time may be displayed on monitors within the terminal, etc.

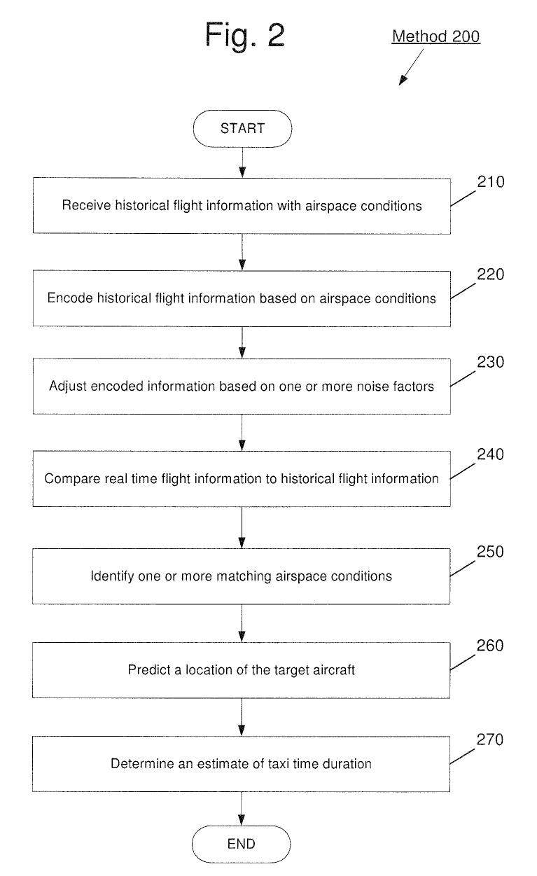

FIG. 2 shows an exemplary method 200 for predicting a taxi time duration for aircraft and/or an airport. The method 200 will be described with reference to the exemplary system 100 and the corresponding components of FIG. 1. As noted above, several interdependent factors and unknown future events may occur while generating prediction calculations. These unknown factors and events may be referred to as noise. Accordingly, the exemplary method 200 may take into account and mitigate any number of these factors. However, airports and air traffic patterns are so complex that a prediction model may not be able to account for all of the noise. As will be described in greater detail below, the exemplary method 200 may mitigate many of the noise factors generated from various sources.

In 210, the airport demand server 130 may receive historical flight information including a set of historical airspace conditions at a target airport. The historical flight information may be data that is collected by one or more data sources (e.g., data sources 112 and 111) over an extended period of time (e.g., weeks, months, years, etc.).

In 220, the airport demand server 130 may encode the historical flight information based on the set of historical airspace conditions. The encoding may be based on weather conditions (e.g., rainy, sunny, windy, snowing, etc.), time of day (e.g., morning, afternoon, evening, etc.), type of day (e.g., weekday, weekend, holiday, etc.), airspace condition (e.g., normal, neighboring airports are closed, FAA restrictions, etc.), airport configuration (e.g., current runway configuration, etc.), etc. Thus, it can be seen from these examples that the historical information may be encoded in any number of manners that may be useful in determining the estimated taxi time duration for a target aircraft.

In 230, the airport demand server 130 may adjust the encoded historical flight information based on one or more noise factors. According to an exemplary embodiment of the method 200, noise factors may include late departures, late arrivals, weather conditions, taxi route information, runway and/or taxiway conditions (e.g., configurations, crossings, congestion, closings, etc.), arrival gate conditions, ramp traffic, airport density, (e.g., arrival and departure queue lengths), flight restrictions (e.g., the FAA may restrict departure flow to certain areas and thus affect departure queue lengths, arrivals, etc.).

Each of these noise factors may interdependently affect the airport demand at the target airport. For instance, a late departure may cause further disruptions throughout the remainder of a day as it affects not only the current flight, but all subsequent legs for the necessary equipment. Departing flights may affect one or more arriving flights whenever a departure runway needs to be crossed by the arriving flight. Even if a flight departs on time, weather, traffic and route of travel may alter the expected arrival times of flights. In that regard, significant weather disruptions are a common occurrence and may affect nominal values for a particular flight's taxi time if that flight is scheduled to land during a weather event. Taxi routes may be changed by an airport due to congestion, runway configurations, airport arrival and departure demand, etc.

Once the historical information is encoded and adjusted for any noise factors, the method 200 may advance to 240. In 240, the airport demand server 130 may compare real time flight information of a target aircraft to the encoded historical flight information. According to one exemplary embodiment, the method 200 may utilize pattern matching techniques during the comparison between the real time flight information and the historical flight information. Specifically, pattern matching may be used to determine whether there are any similar conditions between the two type of flight information. As noted above, these similar conditions may be independent of simple time-based conditions, such as time of day, day of the week, etc. Thus, common patterns of operation may be used to predict taxi time durations based on actual historical performance rather than merely relying on discrete time-based events added together to predict a time.

In 250, the airport demand server 130 may identify at least one real time airspace condition of the real time flight information as matching at least one historical airspace condition of the set of historical airspace conditions. For example, the airport demand server 130 may identify similar weather conditions (e.g., rainy) and airport density conditions (e.g., high volume in the departure queue) in the real time flight information that matches conditions within the historical information. Based on these matched conditions, the airport demand server 130 may allow for a more refined prediction of taxi time duration that focuses on the more relevant historical information available. As opposed to generating a prediction simply based on time, the airport demand server 130 is able to account for several other observable factors by estimating aircraft locations using historical performance information under the same or similar conditions. Specifically, historical taxi time information that correspond to the matched conditions may be determined which provide information into non-time-based conditions such as interdependencies.

In 260, the taxi time prediction module 135 of the airport demand server 130 may predict a location of the target aircraft based on the encoded historical flight information. Furthermore, the taxi time prediction module 135 may determine a combined historical performance using the predicted location using the encoded historical flight information as well as the historical taxi time information of actual taxi times observed under corresponding conditions. In this manner, the combined historical performance may incorporate the interdependency between the corresponding conditions (e.g., the time-based or other discrete conditions) and the historical taxi time information. That is, the corresponding conditions and the historical taxi time information is transformed into a more appropriate and greater correlation to the scenario surrounding to the aircraft under review. In 270, a taxi time prediction module 135 may determine an estimate for a taxi time duration for the aircraft based on the predicted location of the target aircraft and the combined historical performance.

Accordingly, the taxi time prediction module 135 may use the passive data collected for the aircraft of interest and combine this with the encoded historical flight information and in conjunction real time flight information to predict a taxi time duration. As part of this prediction, the taxi time prediction module 135 may use historical data for the airport that includes a time that it took previously landed planes from a specific runway (or anywhere on the airport facility) to reach a specified gate. In the case where the aircraft of interest is still in the air, the taxi time prediction module 135 may generate its own taxi time duration and runway ETA or receive a runway ETA from a separate ETA prediction module. In addition, while the aircraft is still in the air, the taxi time prediction module 135 may also use a runway prediction algorithm to determine a predicted runway to use as the landed runway for purposes of calculating the taxi time duration. After the aircraft has landed, the taxi time prediction module 135 may be able to substitute the actual landing time and the actual landed runway for the previously predicted data in order to update the predicted taxi time. After the taxi time duration has been predicted, the airport demand server 130 may then distribute the predicted taxi time to users.

As noted above, the exemplary method 200 may mitigate many of the noise affects by its design. The effects of noise for any of the above-mentioned sources are unpredictable in and of themselves and, when taken together as a whole, create a complex problematic challenge when predicting future results based on discrete event analysis. However, the method 200 may avoid this dilemma by looking at the airspace in a holistic manner. In other words, the method 200 may examine common patterns of operation and use these patterns to predict outcomes based on actual past performance (e.g., historical information including a set of historical airspace conditions at a target airport) rather than interactions of discrete events added together to predict a time.

Accordingly, the systems and methods described herein look at key factors that are better predictors of outcome than simply predicting discrete events. The holistic features are overall indicators of airport capacity such as arrival and departure queue lengths, arrival runways, significant air traffic initiatives, etc. These indicators are invariant to disruptions caused by significant weather delays at the arrival airport or major hubs throughout the world. The exemplary systems and methods are thus invariant to any other factors or events caused by schedule disruptions and further invariant to the effects of the runways with regard to taxi time. This is due to the fact that the runway at any airport is the necessary constant for all members of the class of flights used for historical comparisons.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system such as Microsoft Windows, a Mac platform and MAC OS, a Linux OS, a mobile device having an operating system such as iOS or Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving historical flight information including a set of historical airspace conditions at a target airport;
comparing real time flight information of a target aircraft to the historical flight information;
identifying at least one real time airspace condition of the real time flight information as matching at least one historical airspace condition of the set of historical airspace conditions;
determining historical taxi time information corresponding to the at least one historical airspace condition of the set of historical airspace conditions;
determining a combined historical performance based on the matched at least one real time airspace condition and the historical taxi time information, the combined historical performance incorporating an interdependency between discrete characteristics of the matched at least one real time airspace condition and the historical taxi time information; and
determining an estimate for a taxi time duration for the aircraft based on the combined historical performance.

2. The method of claim 1, wherein the historical airspace conditions include an expected airport density information based on arrival and departure aircraft information at the target airport.

3. The method of claim 1, further comprising:
encoding the historical flight information based on the set of historical airspace conditions, the encoded historical flight information being defined by normalized descriptors.

4. The method of claim 3, further comprising:
adjusting the encoded historical flight information based on at least one noise factor.

5. The method of claim 4, wherein the noise factor comprises one of late departures, late arrivals, weather conditions, taxi route information, runway conditions, taxiway conditions, arrival gate conditions, ramp traffic, airport density, flight restrictions, or a combination thereof.

6. The method of claim 1, further comprising:
predicting a location of the target aircraft based on the encoded historical flight information.

7. The method of claim 1, wherein the historical taxi time information is derived from passive and active radar sources.

8. The method of claim 1, wherein the historical taxi time information is associated with phases of a flight.

9. The method of claim 8, wherein the phases of the flight is out of a departure gate, off the ground, on the ground at a destination airport, and in the arrival gate.

10. The method of claim 1, wherein the historical taxi time information is associated with actual and predicted runway usage information.

11. The method of claim 1, wherein the historical taxi time information is associated with one of estimated times of arrivals, past taxi times, airport active runway configurations, Notice to Airmen conditions, or a combination thereof.

12. The method of claim 1, wherein the determining the combined historical performance utilizes pattern matching techniques independent of the discrete characteristics.

13. The method of claim 1, further comprising:
receiving landed runway information; and
determining a predicted runway that the aircraft is going to land.

14. The method of claim 1, further comprising:
distributing the estimate for the taxi time duration to requesting users.

15. An airport demand server, comprising:
a transceiver configured to receive historical flight information including a set of historical airspace conditions at a target airport; and
a taxi time prediction module comparing real time flight information of a target aircraft to the historical flight information, the taxi time prediction module identifying at least one real time airspace condition of the real time flight information as matching at least one historical airspace condition of the set of historical airspace conditions, the taxi time prediction module determining historical taxi time information corresponding to the at least one historical airspace condition of the set of historical airspace conditions, the taxi time prediction module determining a combined historical performance based on the matched at least one real time airspace condition and the historical taxi time information, the combined historical performance incorporating an interdependency between discrete characteristics of the matched at least one real time airspace condition and the historical taxi time information, the taxi time prediction module determining an estimate for a taxi time duration for the aircraft based on the combined historical performance.

16. The airport demand server of claim 15, wherein the historical airspace conditions include an expected airport density information based on arrival and departure aircraft information at the target airport.

17. The airport demand server of claim 15, wherein the taxi time prediction module adjusts the historical flight information based on at least one noise factor.

18. The airport demand server of claim 17, wherein the noise factor comprises one of late departures, late arrivals, weather conditions, taxi route information, runway conditions, taxiway conditions, arrival gate conditions, ramp traffic, airport density, flight restrictions, or a combination thereof.

19. The airport demand server of claim 15, wherein the transceiver is configured to distribute the estimate for the taxi time duration to requesting users

20. A non-transitory computer readable storage medium with an executable program stored thereon, wherein the program instructs a microprocessor to perform operations comprising:
receiving historical flight information including a set of historical airspace conditions at a target airport;
comparing real time flight information of a target aircraft to the historical flight information;
identifying at least one real time airspace condition of the real time flight information as matching at least one historical airspace condition of the set of historical airspace conditions;
determining historical taxi time information corresponding to the at least one historical airspace condition of the set of historical airspace conditions;
determining a combined historical performance based on the matched at least one real time airspace condition and the historical taxi time information, the combined historical performance incorporating an interdependency between discrete characteristics of the matched at least one real time airspace condition and the historical taxi time information; and
determining an estimate for a taxi time duration for the aircraft based on the combined historical performance.
